(19) United States
(12) Patent Application Publication
(10) Pub. No.: US 2001/0005075 A1
(43) Pub. Date: Jun. 28, 2001

(54) Vehicle occupant restraint system

(75) Inventor: Christian Lorenz, Leidersbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH & Co. KG

(21) Appl. No.: 09/735,449

(22) Filed: Dec. 13, 2000

(30) Foreign Application Priority Data
Dec. 13, 1999 (DE) 299 21 857.0

(51) Int. Cl. B60R 21/16

(52) U.S. Cl. 280/728.2

(57) ABSTRACT

The invention relates to a vehicle occupant restraint system, comprising a gas bag module which has a front side, a side face and a rear side. The gas bag module further comprises a pot-shaped module cover having a first peripheral wall and an accommodation housing having a second peripheral wall. The module cover and the accommodation housing define a space for accommodating a gas bag as part of the module. The first and second peripheral walls are connected with each other by a latching connection and at least one of the peripheral walls defines the side face. A mounting body for the gas bag module in the form of a hub pot of a vehicle steering wheel is provided. The mounting body is disposed so close to the side face that it laterally supports the laterally outer one of the first and second peripheral walls upon opening of the gas bag module and secures the latching connection.

### TECHNICAL FIELD

This invention relates to a vehicle occupant restraint system.

### BACKGROUND OF THE INVENTION

Gas bag modules in vehicle steering wheels usually have a plastic cover which forms the front side that is associated to the passenger compartment. To save costs, the pot-shaped module covers are not screwed or riveted to supporting module covers. Rather, latching connections are provided, which have mounting lugs, so that upon insertion of the gas bag into the accommodation housing the module cover is only placed upon the accommodation housing and at the same time the latching connection is locked. Upon deployment of the gas bag the cover will tear open at the front side and swivel to the outside. The associated peripheral wall of the cover is thus also bent to the outside. This might lead to the latching connection coming loose. To counteract such loosening, it is known to provide a separate locking plate which is screwed to the rear side of the accommodation housing. This locking plate is laterally bent toward the front side close to the side face of the module and supports the peripheral wall of the module cover, which can no longer bend to the outside to such an extent that the latching connection comes loose. Providing a locking plate and mounting the same, however, increase the costs involved. The locking plate need not necessarily be angled, but other embodiments are conceivable as well.

### BRIEF SUMMARY OF THE INVENTION

The invention provides a vehicle occupant restraint system in which the latching connection between the two peripheral walls is secured in a simpler and less expensive way. This is achieved by a vehicle occupant restraint system which comprises a gas bag module which has a front side, a side face and a rear side. The gas bag module further comprises a pot-shaped module cover having a first peripheral wall and an accommodation housing having a second peripheral wall. The module cover and the accommodation housing define a space for accommodating a gas bag as part of the module. The first and second peripheral walls are connected with each other by a latching connection and at least one of the peripheral walls defines the side face. A mounting body in the form of a hub pot of a vehicle steering wheel for the gas bag module is provided. The mounting body is disposed so close to the side face that it laterally supports the laterally outer one of the first and second peripheral walls upon opening of the gas bag module and that it secures the latching connection. Thus, the invention no longer provides a separate sheet of metal only present for the purpose of securing the latching connection, but the building space around the gas bag module in the steering wheel is rather designed such that the mounting body, which is provided in any case and defines the building space, effects such locking.

In place of the correspondingly shaped hub of the vehicle steering wheel, the mounting body may also be a correspondingly shaped metal mounting plate in the dashboard or corresponding mounting parts in the vehicle seat, a corresponding portion of the roof frame or the door frame. Preferably, the mounting body is a correspondingly shaped portion of a frame member.

In the preferred embodiment, the first peripheral wall is the laterally outer one. It is thus ensured that the gas bag in the folded condition can laterally abut against the accommodation housing and have the maximum possible width.

In accordance with a further aspect, the module cover is made of plastics and the accommodation housing is made of sheet metal, where the accommodation housing may of course also be made of plastics.

The accommodation housing advantageously has latching hooks laterally protruding into recesses in the first peripheral wall, which hooks form the latching connection with the recesses. The latching hooks may, however, also be provided in the reverse case at the peripheral wall, and the recesses may be provided in the accommodation housing.

According to a further design, the mounting body towards the front side preferably extends laterally outwards and thus provides for a certain bending of the peripheral wall of the module cover to the outside, when the front side of the module cover is torn open.

In the non-deployed condition of the gas bag, the mounting body preferably already rests against the outer peripheral wall. The mounting body in addition serves to laterally fix the position of the gas bag module in the vehicle, and thus has a dual function in this case.

### BRIEF DESCRIPTION OF THE DRAWINGS

FIG. 1 shows a longitudinal section through an embodiment of the vehicle occupant restraint system according to the invention, where the left-hand half represents the prior art and the right-hand half represents the invention,

FIG. 2 shows an enlarged view of the latching connection to be used in the invention in accordance with an embodiment,

FIG. 3 shows an enlarged view of another latching connection to be used in the invention, and

FIGS. 4 to 7 show longitudinal sections through another four embodiments.

### DETAILED DESCRIPTION OF THE PREFERRED EMBODIMENTS

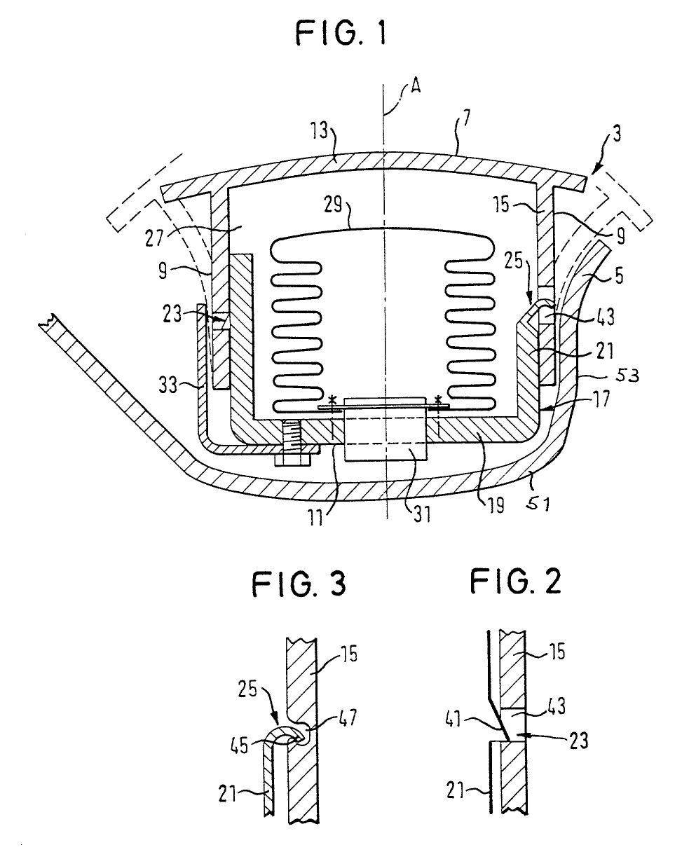

FIG. 1 shows a vehicle occupant restraint system which comprises a gas bag module 3 and a mounting body 5. The mounting body 5 is a hub pot, for instance, a pot-shaped hub of the vehicle steering wheel. The mounting body may also be a mounting plate in the vicinity of the dashboard on the passenger side, in the seat, the side door or the roof frame. The hub pot need not be constituted by the hub of the steering wheel only and also need not be closed peripherally; it being sufficient that spoke sections, the foam casing of the spokes or further parts anyway provided in the vicinity of the module 3 protrude toward a front side 7 of the module. The gas bag module comprises the above-mentioned front side, a side face 9 and a rear side 11. The gas bag module furthermore consists of a pot-like module cover 13 with a closed peripheral wall 15, which is subsequently referred to as first peripheral wall. Moreover, the gas bag module consists of a preferably inversely pot-shaped accommodation housing 17 of sheet metal. This accommodation housing 17 has a rear wall 19 and a peripheral wall 21, subsequently referred to as second peripheral wall. The first and second peripheral walls 15, 21 contact each other and are fixed at each other by a plurality of latching connections 23, 25. The latching connections are designed such that pushing the module cover 7 onto the accommodation housing 17 is possible, but not a withdrawal of the module cover.

In the upper region, the side face 9 is defined by the outside of the first peripheral wall 15, and in the lower region it is defined by the outside of the peripheral wall 21. Module cover 7 and accommodation housing 17 define a space 27 for accommodating a gas bag 29. The gas bag 29 is represented only in a stylized way and in practice rests against the peripheral wall 21 and fills almost the entire space 27. In the vicinity of the rear wall 19 a gas generator 31 is mounted at the accommodation housing 17.

To the left of the axis A a restraint system is represented, which is already known. Since upon deployment of the gas bag the module cover 7 tears at the front side and swivels to the outside, the peripheral wall 15 is also urged to the outside, as is indicated in broken lines. The peripheral wall 15 might be swiveled to the outside to such an extent that the latching connection 23 comes loose. To prevent this, a pot-shaped locking plate 33 is screwed to the accommodation housing from below. The portion of the locking plate protruding towards the front side 7 almost rests against the first peripheral wall 15 and prevents an excessive bending of the peripheral wall 15 upon deployment of the gas bag.

It can be seen that the locking plate 31 requires an additional production and mounting effort.

In the embodiment according to the invention, which is represented in the right-hand half of FIG. 1, the locking plate designed as a separate member and fixed at the gas bag module 3 is dispensed with. In the invention, the mounting body 5 (hub pot) is shaped such that it extends close to the peripheral wall 15, which constitutes the laterally outer one of the two peripheral walls 15, 21, so that it partly rests against this wall 15. The mounting body 5 thus effects a locking of the module cover, whose peripheral wall 15 is held between the second peripheral wall 21 and the mounting body 5, so to speak. For the mounting body 5 no separate part is required, but only a corresponding shaping, the costs of which are, however, not relevant. In addition, the mounting body 5, which is fixed at the side of the vehicle and constitutes a vehicle frame member, is that vehicle-fixed part at which the gas bag module 3 is arrested. In the embodiment according to FIG. 1 the mounting body is a pot-shaped hub of the steering wheel, this hub comprising a base 51 and a side wall 53 which is closed peripherally.

It is appreciated that the two peripheral walls 15, 21 need not be closed peripherally, but that corresponding portions can also perform the functions described above. Likewise, the mounting body 5 need not be used for fixing the gas bag module 3 at the same time. The mounting body 5 can rather be composed of a plurality of adjacent parts, where one part is used for fixing the gas bag module 3 and an adjacent part is placed so close to the peripheral wall 15 that it can be used for locking purposes.

In FIGS. 2 and 3 various forms of the latching connection are represented. Both latching connections can of course be used in the invention. The latching connection 23 represented in FIG. 2 consists of a punched and laterally outwardly bent hook-shaped projection 41 as part of the peripheral wall 21 as well as a recess 43 in the peripheral wall 15.

The latching connection 25 represented in FIG. 3, however, consists of an upper edge portion 45 of the peripheral wall 12, which is bent to form a hook, and a corresponding recess 47 in the peripheral wall 15, which is likewise hook-shaped in cross-section, but where the recess 47 does not penetrate the peripheral wall 15.

In FIG. 1 it is also shown in the right-hand half that the mounting body 5, towards the front side 7, extends laterally outwards and that the peripheral wall 15 rests against the outwardly expanded upper portion of the mounting body 5. Upon deployment of the gas bag, the mounting body 5 laterally supports the peripheral wall 15, thereby securing the latching connection 25 or 23.

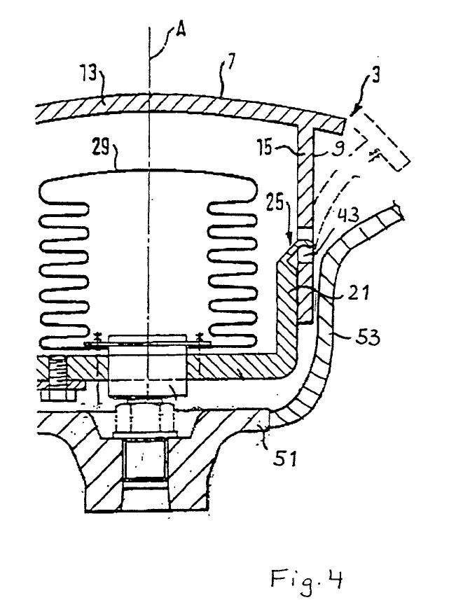

In the embodiments according to FIGS. 4 to 7 there are used the already introduced reference numerals for the parts already explained. Further, only the right-hand half of the section view is completely illustrated for the sake of simplification.

According to FIG. 4 the hub pot is constituted by the skeleton of the steering wheel, i.e. by the hub forming the base 51, and by the skeleton of the spokes which are secured to the hub and form the side wall 53 which is not closed peripherally. Upon opening of the module, the side face 9 abuts against the skeleton of the spokes, i.e. at the side wall 53.

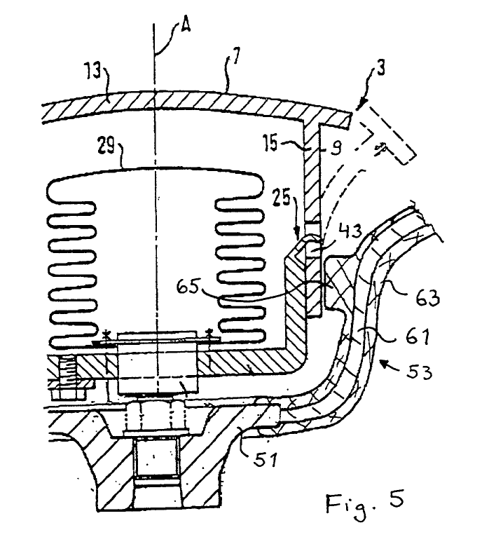

FIG. 5 mainly corresponds to FIG. 4, the skeleton 61 of the spokes, however, having a foam casing 63 with a radially inwardly running protrusion 65 as a stop for the outer peripheral wall 15.

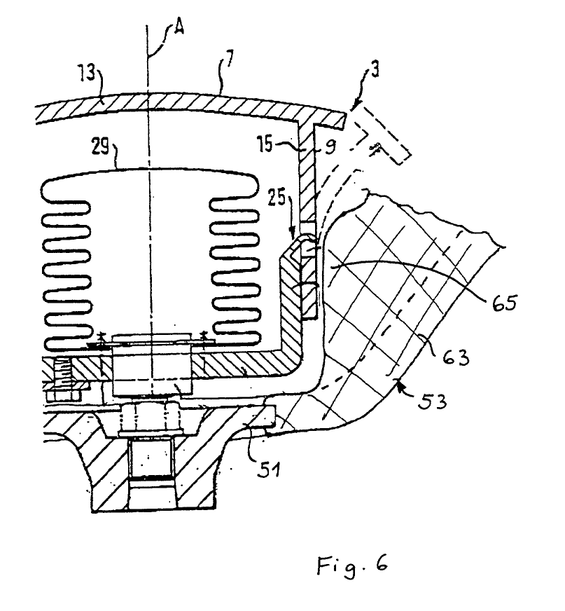

In the embodiment of FIG. 6 the skeleton of the spoke lies out of the section plane. The skeleton is provided with a foam casing 63 which gives a shape to the hub pot which is closed peripherally. The protrusion 65, against which the peripheral wall 15 abuts, lies between two spokes.

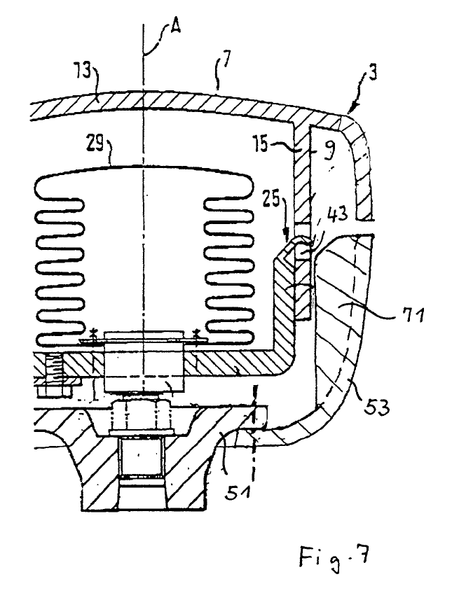

In the embodiment of FIG. 7 the base 51 is constituted by the steering wheel hub and the side wall 53 by a steering wheel lining in the shape of a plastic shell which is attached to the hub at the rear side. The peripheral wall is supported by this plastic shell upon opening of the module. A rib 71 prevents the peripheral wall 15 from being detached.

1. A vehicle occupant restraint system, comprising a gas bag module which has
a front side, a side face, and a rear side, and
a pot-shaped module cover having a first peripheral wall, and
an accommodation housing having a second peripheral wall,
said module cover and said accommodation housing defining a space for accommodating a gas bag as part of said module, and
said first and second peripheral walls being connected with each other by a latching connection and at least one of said peripheral walls defining said side face,
a mounting body for said gas bag module in the form of a hub pot of a vehicle steering wheel being provided,
said mounting body being disposed so close to said side face that it laterally supports the laterally outer one of said first and second peripheral walls upon opening of said gas bag module and that it secures said latching connection.

2. The vehicle occupant restraint system as claimed in claim 1, wherein said first peripheral wall is said laterally outer one.

3. The vehicle occupant restraint system as claimed in claim 1, wherein said module cover is made of plastics and said accommodation housing is made of sheet metal.

4. The vehicle occupant restraint system as claimed in claim 1, wherein said accommodation housing has latching hooks and said first peripheral wall comprises recesses, said hooks laterally protruding into said recesses.

5. The vehicle occupant restraint system as claimed in claim 1, wherein said mounting body rests against said outer peripheral wall in a non-deployed condition of said gas bag.

6. The vehicle occupant restraint system as claimed in claim 1, wherein said mounting body, towards said front side, extends laterally outwardly.

7. The vehicle occupant restraint system as claimed in claim 1, wherein a hub and several spokes are provided, said hub pot being constituted by said hub and said spokes and said outer peripheral wall being supported by said spokes upon opening of said gas bag module.

8. The vehicle occupant restraint system as claimed in claim 7, wherein said spokes include a skeleton, said outer peripheral wall being supported by said skeleton of said spokes upon opening of said gas bag module.

9. The vehicle occupant restraint system as claimed in claim 7, wherein said spokes have a foam casing, said outer peripheral wall being supported by said foam casing upon opening of said gas bag module.

10. The vehicle occupant restraint system as claimed in claim 9, wherein said foam casing has a protrusion extending towards said outer peripheral wall and serving as a stop for said outer peripheral wall.

11. The vehicle occupant restraint system as claimed in claim 9, wherein said foam casing gives a shape to said hub pot which is closed in peripheral direction.

12. The vehicle occupant restraint system as claimed in claim 7, wherein said hub pot consists of a base and a side wall, said base being constituted by said hub of said steering wheel and said side wall being constituted by a plastic shell which is secured to said hub and supports said peripheral wall upon opening of said gas bag module.
